(19) United States
(12) Patent Application Publication
(10) Pub. No.: US 2004/0047241 A1
(43) Pub. Date: Mar. 11, 2004

(54) Wearable wrist watch means having function for detecting unlawful recorded radio audio/video signals

(76) Inventor: Yuan Sung Weng, Taipei (TW)

Correspondence Address: BUCKNAM AND ARCHER, 1077 Northern Blvd., Roslyn, NY, 11576, US

(21) Appl. No.: 10/639,803

(22) Filed: Aug. 12, 2003

(30) Foreign Application Priority Data
Sep. 10, 2002 (TW) 091214205

(51) Int. Cl. G04B 47/06

(52) U.S. Cl. 368/11

(57) ABSTRACT

The present invention provides a wearable wrist watch means having function for detecting unlawful recorded radio audio/video signals, comprising a housing, a display unit, a control circuit unit, a memory unit, an input unit, a toggle switch, a chronometric unit, a power supply and a radio multi-frequency scanner having a frequency modulation unit and a radio multi-frequency scanning unit. A user can detect at any time an unlawful recorded radio audio/video signals by means of the wearable wrist watch means with various radio frequencies and, a value of the detected frequency and strength of the detected signal also can be displayed on the display unit, and an additional buzzer of the watch means will be energized for functioning.

### BACKGROUND

1. Field of the Invention

The present invention generally to a wearable wrist watch means having function for detecting unlawful recorded radio audio/video signals and, more particularly to a carry-on timer means having functions for both general time indication and for detecting unlawful recorded radio audio/video signals.

2. Description of the Prior Art

Recently, an audio-video (that is, voice and image) recorder, for example, video camera, is constituted into very compact, this minimized video camera can thus be installed at any concealable location to record specific secrets and/or peep people's private behaviors, especially, an existing miniature RF (Radio Frequency) signal transmitter may be built in the above-mentioned video camera to send the unlawful recorded audio-video signals to a remote receiver device for recording and/or regeneration at real time, even if these conducts are absolutely inhibited but there is no way of preventing it.

Conventionally, a kind of frequency counter such as model FC1000/FC2000 series products, fabricated by ACECO ELECTRONICS, Corp. is utilized as the means for detecting unlawful recorded radio audio/video signals, RF signal with ranges between 10 HZ to 50 MHZ and 1 MHZ to 3 GHZ outgoing from the RF transmitter can be respectively detected depending on a selection of input impedance value from 50 Ω and 1 MΩ so as to catch the audio/video signals. However, the frequency counter is not suitable for general usage, since it has a larger dimension and it is a specifically professional application.

Therefore, there is need for developing a compact, convenient and costly means that provides a function for detecting various RF signals at any time and any place to exactly find out where the video camera was unlawfully hidden.

### SUMMARY OF THE INVENTION

The major object of the present invention is to provide a wearable wrist watch means having function for detecting unlawful recorded radio audio/video (that is, voice and image) signals, the measurement of which is very compact to be convenient for carrying-on and, the detecting function can be carried out at any time and any place.

To do so, in a specific embodiment, the invention provides a wearable wrist watch means having function for detecting unlawful recorded radio audio/video signals, which is to be used for detection of radio frequency and normal indication of time, the wearable wrist watch means comprises a housing used to define a space for receiving a control circuit unit used for data processing, timing and activity controlling of correspond components; a display unit used to display time and data; a memory unit used to store data; an input unit used to input data and output a control signal to the control circuit unit, the control circuit unit processes data then activates each component based on the control signal; a timer used to indicate time as the same as that of a common watch; and a power supply, for example a battery, used to provide operating voltage. The wearable wrist watch means according to the invention further includes a radio multi-frequency scanner disposed within the housing, the radio multi-frequency scanner contains a radio frequency scanning unit and a frequency modulation unit for scanning and detecting radio frequencies, and a toggle switch used to regulate the band width and input data of the radio multi-frequency scanner.

Furthermore, the display unit in the above embodiment according to the present invention can be a kind of liquid crystal display, and the data shown in the display unit further contains the value and strength of the detected frequency.

In addition, there is an extensible antenna provided on the wearable wrist watch means that is to be suitably extended for corresponding to a frequency which is detected, and a buzzer will be energized to indicate the signal strength of the detected radio frequency.

### BRIEF DESCRIPTION OF DRAWINGS

These and other objects, features and advantages in accordance with the present invention will be more apparent in conjunction with the following description and drawings, wherein corresponding reference numerals depict corresponding parts.

FIG. 1 is a block diagram showing a schematic construction of a wearable wrist watch means having function for detecting unlawful recorded radio audio/video signals of a preferred embodiment according to the present invention.

FIG. 2 is a profile showing a configuration of the wearable wrist watch means according to the present invention.

### DETAILED DESCRIPTION OF THE INVENTION

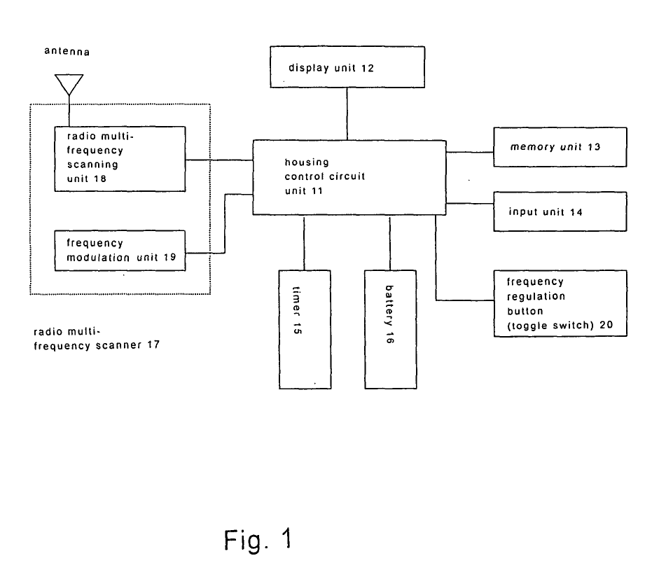

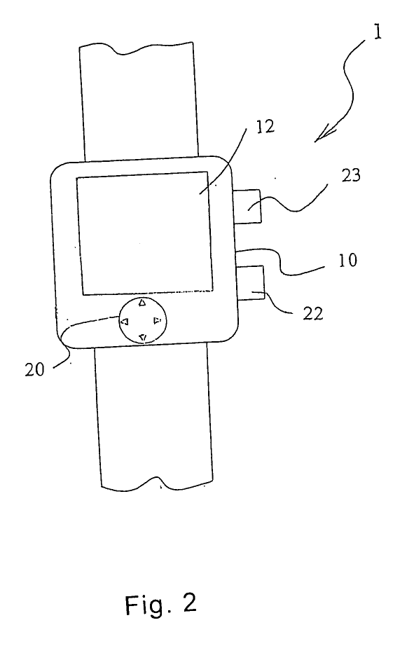

Referring now to FIGS. 1 and 2, the FIGS. 1 and 2 show a schematic construction of the wearable wrist watch means having function for detecting unlawful recorded radio audio/video signals of a preferred embodiment in accordance with the present invention. The wrist watch means 1 includes a housing 10, a control circuit unit 11, a display unit 12, a memory unit 13, an input unit 14, a chronometer 15, a battery 16, a toggle switch (or a frequency regulation button) and a radio multi-frequency scanner 17 having a radio frequency scanning unit 18 and a frequency modulation unit 19.

As shown in the figures, the housing 10 defines a space to contain corresponding parts; the control circuit unit 11 is disposed in the housing 10 for data processing and activating correspondent components, the control circuit unit 11 will be described hereinafter; the memory unit 13 is also mounted in the housing 10 to store data that can be pre-stored in the memory unit 13 or downloaded into the memory unit 13 from additional electronic devices (not shown) through a transmitting interface, the data can be a configuration of images, characters and datum; a user can operate a control key 23 to input a data and a control signal to the input unit 14, then the input unit 14 outputs the same to the control circuit unit 11, the control circuit unit 11 is functioned to execute data processing, timing and control corresponding activity of corresponding component upon a determined mode entered by a selective key 22.

The display unit 12 can be a liquid crystal display or the like, used for showing the time and the data as mentioned-above, wherein the data is controlled by the operation of the selectable switch 22 through the control circuit unit 11. The chronometer 15 provides a data of timing and the data is presented in the display unit 12 during the timing mode being selected. The power supply 16 (battery) applies an operating voltage to corresponding components for executing corresponding functions.

In addition, the wearable wrist watch means 1 according to the present invention further contains a radio multi-frequency scanner 17 having a radio frequency scanning unit 18 and a frequency modulation unit 19 for scanning and detecting a frequency of a radio signal in which the radio frequency scanning unit 18 catches a radio signal which is to be detected in accordance with a predetermined sampling time, then, the frequency of the radio signal is demodulated by the frequency modulation unit 19 and, appeared in the display unit, the radio frequency scanning unit 18 and the frequency modulation unit 19 can be formed into a miniature module by a micro electromechanical technology; An extensible antenna 21 can be optionally provided on the watch means 1 so as to correspond to a frequency to be detected; and a toggle switch 20, which is used to regulate band width of the frequency and input data, that is, the toggle switch 20 can be functioned as either a regulation button for controlling band width of the frequency modulation unit 19 or a input button for input of data, however, if necessary, the toggle switch 20 can be constructed to contain additional functions such as to operate for exchanging frequency display, display of period, auto-locked, temporary-store and display, therefore, number of operative keys on the watch means 1 will be reduced so as to be convenient in operation and clear in construction.

Moreover, a buzzer (not shown) can be further provided in the watch means 1, the time interval of intermittent operation of the buzzer upon the detected signal strength of the radio frequency will be variable, an indication of the distance between the user and the detected signal source is obtained therefrom.

An interaction between the control circuit unit 11 and each component will be described hereinafter. Initially, one specific mode of multi-modes including timing mode, input mode and test mode can be selected by the selective key 22. In case of the timing mode is selected, a timer function will be appeared on the display unit 12 by virtue of the operation of the control key 23 through the control circuit unit 11. When the input mode is selected, a data is input and updated over the input unit 14 to execute data processing, to cause the data storage in the memory unit 13, and to instruct the display unit 12 to show the corresponding data; and, when the test mode is selected, selectable functions such as display of exchangeable frequency, display of period, auto-locked and the temporary store together with display of the detected radio frequency, used for detection of radio frequency can be controlled by the control key 23 and the toggle switch 20 through the control circuit unit 11.

Although the present invention has been described in accordance with the embodiment shown, one of ordinary skill in the art will readily recognize there could be variations and modifications to the embodiment and these variations and modifications would be within the spirit and scope of the present invention.

List of Reference Numerals

1 wearable wrist watch means

10 housing

11 control circuit unit

12 display unit

13 memory unit

14 input unit

15 timer

16 battery

17 radio multi-frequency scanner

18 radio multi-frequency scanning unit

19 frequency modulation unit

20 frequency regulation button (toggle switch)

21 antenna

22 selective key

23 control key

What is claimed is:

1. A wearable wrist watch means having function for detecting unlawful recorded radio audio/video signals to detect radio frequency and display time and data, the watch means contains a housing, the housing defines a space to receive the following parts:
a control circuit unit used to process data, measure time and control actuation of each component;
a display unit for displaying the measured time and data;
a memory unit for storing data;
an input unit for inputting data and control signal to the control circuit unit, the actuation of each component is capable of being controlled based on the processed data and the control signal of the control circuit unit;
a chronometer used to provide a timing data;
a battery for applying an operating voltage;
a radio multi-frequency scanner disposed within the housing, the radio multi-frequency scanner comprises a radio multi-frequency scanning unit and a frequency modulation unit for scanning and detecting radio frequency; and
a toggle switch for regulating the band width of the radio multi-frequency scanner and inputting data.

2. The wearable wrist watch means as defined in claim 1, wherein the display unit is a liquid crystal display and, which displays the value and strength of the detected radio frequency.

3. The wearable wrist watch means as defined in claim 1, wherein the watch means further contains a built-in extensible antenna, the length of the antenna is adjustable to correspond to a radio frequency which is to be detected; and a buzzer functioned to indicated a signal strength of the detected radio frequency.
